(19) United States
(12) Patent Application Publication
(10) Pub. No.: US 2014/0354414 A1
(43) Pub. Date: Dec. 4, 2014

(54) RFID AND APPARATUS AND METHODS THEREFOR

(71) Applicant: RFID Technologies Pty Ltd, Queenscliff, Victoria (AU)

(72) Inventors: Nemai Karmakar, Wheelers Hill (AU); Prasanna Kalansuriya, Clayton (AU)

(21) Appl. No.: 14/364,066

(22) PCT Filed: Dec. 7, 2012
(86) PCT No.: PCT/AU2012/001494

§ 371 Date: Jun. 9, 2014

(30) Foreign Application Priority Data
Dec. 7, 2011 (AU) 2011905098

(51) Int. Cl. G06K 7/10; G06K 19/067

(52) U.S. Cl. CPC G06K 7/10297; G06K 19/0672; G06K 7/10316; G06K 7/10118
USPC 340/10.3; 235/492; 235/439

(57) ABSTRACT

A method of reading an RFID tag (30) including receiving, from the tag, a signal (50) including a structural mode (54) and an antenna mode (56), and selectively analysing a time period of the received signal corresponding to the antenna mode.

### FIELD

This invention relates to radio frequency identification (RFID) and to apparatus and methods therefor.

### BACKGROUND

RFID is a wireless data capturing technology that uses radio frequency (RF) waves for extracting encoded data from remotely placed tags. RFID systems have two main elements, the RFID tag, where data is encoded, and the RFID reader, which is used for extracting the encoded data from the tags. “Tag” refers to a device in which data is encoded and places no limitation on the physical size and shape of the device.

“Active” RFID tags incorporate a battery whereas “passive” RFID tags take their energy from an interrogation signal.

An RFID tag, like a barcode, can be used to identify and characterise an item to which it is attached. At least preferred forms of RFID have numerous advantages over the barcode, including a long reading range, non-line-of-sight reading, and automated identification and tracking.

RFID tags are considered unsuitable for low-cost applications because of their higher price compared to the barcode. The cost of the widely-used passive tags is largely attributable to their Application Specific Integrated Circuit (ASIC). Printable chipless RFID tags are a lower cost option. Chipless RFID tags have no integrated circuit (chip) and are essentially passive reflectors or absorbers of electro-magnetic radiation. However, the removal of the chip from the tag makes it inflexible for the encoding of higher numbers of bits within a small tag. It is desirable to maximise the amount of information which can be conveyed by an RFID tag of a given size and to maximise the range over which it may be read.

“Frequency signature base tags” reflect to a reader a return signal including identifiable features at frequencies selected from a pre-determined set of frequencies. The presence of a feature at an expected frequency conveys a bit of information whereby the tag carries information encoded by the selection of frequencies. In contrast “time domain reflectometry (TDR)” based tags produce return signals having identifiable features spaced in time. The presence of a feature at an expected time conveys a bit of information.

Frequency signature based tags are capable of storing more information than TDR tags, however the operation of frequency signature based tags at longer reading ranges requires appropriate orientation and calibration tags in order to remove effects of interference due to clutter and antenna coupling. TDR based tags do not face these constraints and operate at longer ranges.

It is an object of the invention to provide improvements in and for RFID, or at least to provide an alternative for those concerned with RFID.

It is not admitted that any of the information in this patent specification is common general knowledge, or that the person skilled in the art could be reasonably expected to ascertain or understand it, regard it as relevant or combine it in any way at the priority date.

### SUMMARY

The inventors have recognised that the return signal from a chipless RFID tag consists of two main components. The first component is the “structural mode” which is caused by surface currents induced on the surface of the tag antenna by an interrogation signal. The structural mode depends on the shape of the tag antenna, its size and material properties irrespective of its ability to capture or transmit RF signals. The second component is the “antenna mode” due to the radiation captured by the tag.

The inventors have recognised that the information encoded on the tag is carried by the antenna mode. Accordingly the invention in its various aspects relates to analysing the antenna mode in preference to the structural mode and to delaying the antenna mode so that it may more readily be distinguished from the structural mode.

One aspect of the invention provides a method of reading an RFID tag including receiving, from the tag, a signal including a structural mode and an antenna mode; and selectively analysing a time period of the received signal corresponding to the antenna mode.

The selectively analysing preferably includes identifying within the received signal features at selected frequencies of a predetermined set of frequencies.

The method may include identifying a predetermined delay, from a portion of the received signal to another portion of the received signal, to identify the time period. By way of example, the portion may be a structural mode of the received signal and the other portion may be the antenna mode.

Preferred forms of the invention include subtracting an estimate of unwanted signal content to identify the received signal. The estimate may correspond to a signal when no tag is present.

The selectively analysing may include Fourier analysis.

An interrogation signal may be transmitted to the tag to create the signal from the tag. The interrogation signal is preferably a pulse containing a broadband of frequencies. Most preferably the interrogation signal is less than a nanosecond in duration.

Preferably the tag is chipless.

Another aspect of the invention provides a reader for reading an RFID tag including

an antenna for receiving, from the tag, a signal including a structural mode and an antenna mode; and

a logic arrangement configured to selectively analyse a time period of the received signal corresponding to the antenna mode of the received signal.

Another aspect of the invention provides a chipless RFID tag including

one or more structures responsive to an interrogation signal to create features at selected frequencies in an antenna mode of a return signal; and

at least one elongate conductive pathway co-operable with the structures to delay the antenna mode from a structural mode of the return signal.

Preferably the tag carries information encoded by the selection of the frequencies from a predetermined set of frequencies. Preferably the predetermined frequencies are respectively separated by at least about 200 MHz.

The pathway is preferably dimensioned to delay the antenna mode from a structural mode such that the delay between the antenna mode and the structural mode is at least about 0.6 ns, or more preferably at least about 3 ns.

One or more of the structures may be positioned along the pathway.

Some variants of the tag may have a frequency selective antenna including one or more of the structures.

One or more of the structures may be passive filters, e.g. spiral filters.

Optionally an or the antenna receives the interrogation signal and transmits the return signal, wherein an end of the pathway is arranged to receive energy from the antenna and another end of the pathway is arranged to reflect energy toward the antenna.

Preferably the pathway is shaped such that portions of the pathway run alongside other portions of the pathway.

### BRIEF DESCRIPTION OF DRAWINGS

The figures illustrate various exemplary features.

FIG. 1a schematically illustrates an RFID system;

FIG. 1b is a perspective view of a transmission line and spiral filters;

FIG. 2 is a perspective view of an RFID tag;

FIG. 3 schematically illustrates the operation of the RFID tag of FIG. 2;

FIG. 4 schematically illustrates the operation of an alternate RFID tag;

FIG. 5a is a chart representing the signal received from an RFID tag;

FIG. 5b is an enlargement of portion 5b from FIG. 5a;

FIG. 6 is a close up view of a spiral filter;

FIG. 7 illustrates portions of transmission lines carrying information encoded by the inclusion of selected spiral filters;

FIG. 8 charts the amplitude and phase of return loss and forward transmission parameter of a passive filter;

FIG. 9 charts the spectral content of a received signal;

FIG. 10 schematically illustrates an RFID system;

FIG. 11 charts a UWB interrogation pulse and its frequency spectrum;

FIG. 12a details an RFID tag and its patches;

FIG. 12b charts the return loss profile of each of the patches of FIG. 12a;

FIG. 13a charts a received signal;

FIG. 13b is an enlargement of a portion of FIG. 13a;

FIG. 14 is a chart of the normalised amplitude spectrum of the signal of FIG. 13b;

FIG. 15a is a normalised amplitude spectrum of structural modes;

FIG. 15b is a chart of normalised amplitude spectrums of antenna modes;

FIG. 16a is a front view of a transmit/receive antenna;

FIG. 16b is a front view of an RFID tag;

FIG. 17a is a chart of a normalised measured E-field radiation pattern of the antenna of FIG. 16a;

FIG. 17b is a chart of a measured return loss of the antenna of FIG. 16a;

FIG. 18 is a chart of frequency spectra of different RFID tags placed 30 cm in front of a reader antenna;

FIG. 19 is a chart of frequency spectra of an RFID tag at varying distances from a reader antenna; and

FIG. 20 is a frequency spectra of an RFID tag at varying orientations relative to the reader.

FIG. 21 charts a raised cosine window.

### DESCRIPTION OF EMBODIMENTS

The RFID system 10 includes a reader 20 and an RFID tag 30. The reader 20 includes antennas 22, 24 and logic arrangement 26. The antenna 22 is controlled by the logic arrangement 26 to transmit an interrogation signal 40. The antenna 24 receives, and conveys to the logic arrangement 26, a received signal 50.

“Logic arrangement” is used herein to refer to any mechanism capable of processing data. The term takes in integrated circuits and computers. A logic arrangement may be configured through hard wiring or by software.

The tag 30 includes a tag antenna 32, filters 34 and a meandering transmission line 36. The tag antenna 32 receives the interrogation signal 40, conveys that signal to the filter 34 and transmission line 36, receives a reflected signal from the filters 34 and transmission line 36, and transmits a return signal including structural mode 54 and antenna mode 56. The tag antenna is a UWB monopole antenna. The filters 34 are passive microwave filters for transforming the spectrum of the interrogation signal to encode information into it. The received signal 50 includes three principal components:
interference 52 due to antenna coupling (i.e. the signal travelling directly from the antenna 22 to the antenna 24);
the structural mode 54; and
the antenna mode 56.

Unlike interference 52, the structural mode 54 and antenna mode 56 are portions of a return signal backscattered from the tag 30.

The received signal 50 is plotted in the time domain in FIGS. 5a and 5b. The amplitude of the return signal 54, 56 is about two orders of magnitude smaller than the amplitude of interference 52.

The exemplary tag 30 carries information encoded in the frequency domain, although it is contemplated that variants of the disclosed method may be applied to RFID tags carrying information in ways other than in the frequency domain. The filters 34 are configured to resonate at predetermined frequencies. This resonance absorbs energy from the interrogation signal whereby the antenna mode 56, when plotted in the frequency domain, includes local minima at that frequency. These local minima are detectable features of the antenna mode 56. By forming tags selectively including passive filters having resonances corresponding to respective ones of a predetermined set of frequencies, information may be encoded in the tag.

FIG. 6 is a close up view of a portion of the transmission line 36 including a filter 34. The transmission line is about 2.9 mm wide (dimension A) and separated from the ground plane 38a by a respective 0.3 mm wide (dimension B) slot running along each of its sides. Filter 34 consists of a spiral-shaped slot formed in the transmission line 36. The slot 34 is 0.4 mm wide (dimension C). Adjacent convolutions of the slot are separated by a portion of conductive material 0.3 mm wide (dimension D). The filter 34 occupies a rectangular space on the transmission line 2.5 mm wide (dimension W)×L mm long. The resonant frequency of the filter 34 is controlled by the length L.

The filters 34 serve to filter, i.e. detectably reduce the intensity of, their resonant frequencies from the return signal 54, 56. Thus the inclusion of a filter produces a detectable feature of the return signal 54, 56 in the form of a local minima in the plot of intensity versus frequency. Such a feature may be assigned the binary value of 0, whereby the tag may be encoded by the inclusion of selected filters. By way of example,
FIG. 7a illustrates the filters 34 of a tag encoded with the message “000”;
FIG. 7b illustrates the filters 34 of a tag encoded with the message “010”; and
FIG. 7c illustrates the filters 34 of a tag encoded with the message “100”.

The meandering transmission line 36 serves to delay the antenna mode 56 from the structural mode 54 by a predetermined delay. In this embodiment, the logic arrangement 26 applies time domain based techniques to identify the antenna mode 56. The logic arrangement 26 receives and records the received signal 50. The interference 52 corresponds to a “tag-less” received signal and so can be predetermined. By subtracting this predetermined value from the received signal, the return signal 54, 56 can be separated. The return signal 54, 56 is then analysed to identify peaks in intensity. When two peaks in intensity are identified at the predetermined spacing in time, the latter intense portion is identified as the antenna mode.

Once the antenna mode is identified, it may be analysed in isolation from interference 52 and the structural mode 54. Thus preferred forms of the RFID tag 30 may be read over longer reading ranges than existing frequency domain RFID tags. Preferably the analysis is completed in the frequency domain.

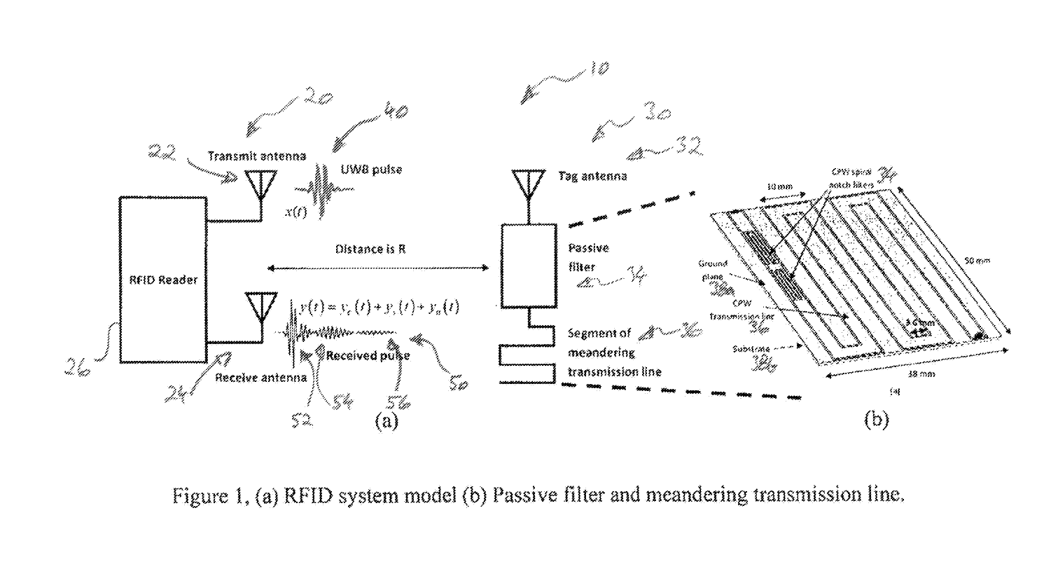

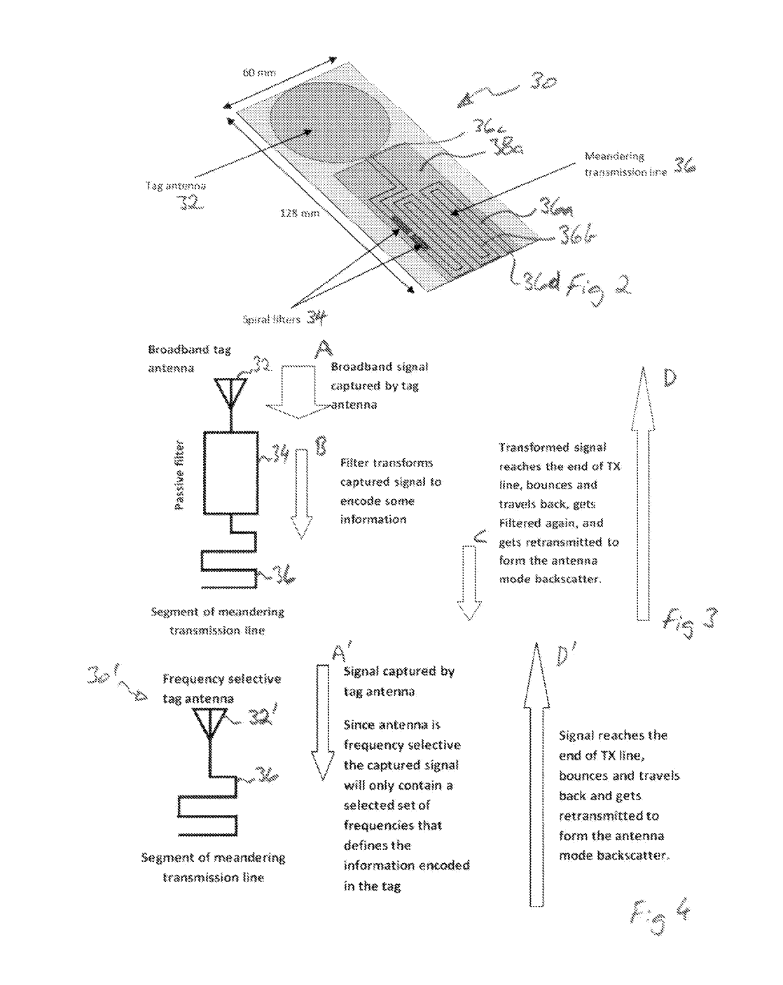

The structure and operation of an exemplary RFID tag are illustrated in more detail in FIG. 1b to FIG. 4. The tag 30 is formed of conductive ink 38a atop a suitable inert substrate 38b. Conveniently the substrate 38b could simply be the item which is to be tagged; i.e. the ink 38a might be printed directly onto an item (or its packaging).

The substrate 38b has a rectangular form 60 mm×128 mm. The tag antenna 32 is a disc of 50 mm in diameter positioned towards one end of the substrate 38b on the long centre line of the substrate 38b.

The meandering transmission line 36 is a conductive pathway extending from the tag antenna 32 and following a serpentine path within a rectangular patch of conductive ink.

The meandering transmission line 36 is defined and separated from other portions of the rectangular patch of conductive ink, by narrow gaps running along its sides. The serpentine path in which portions of the line 36 run alongside other portions of the line 36 (e.g. portion 36a runs alongside portion 36b) is a compact arrangement by which a long conductive pathway may be formed on a chip of small, convenient size.

As suggested by arrow A in FIG. 3, the interrogation signal 40 is received by the tag antenna 32. In this variant of the system 10, the interrogation signal is an ultra-wide bandwidth pulse of sub-nanosecond duration. The intensity of the pulse is at least approximately uniform across a broad band of frequencies. The antenna 32 conveys the received energy to the end 36c of the transmission line 36. From here the energy is conveyed by the meandering transmission line through the spiral filters 34 as suggested by arrow B in FIG. 3. The spiral filters 34 are mounted along the transmission line 36 to selectively absorb energy at their respective predetermined frequencies. From the spiral filters 34, the received energy, now filtered and encoded with information by the filters 34, continues along the transmission line 36 until it reaches the end 36d of the line 36. At the end 36d the signal bounces back (i.e. is reflected) along the transmission line. The reflected energy travels back along the transmission line 36 and is again filtered through spiral filters 34 before returning to and energising the tag antenna 32 to transmit the antenna mode 56 portion of the return signal 54, 56.

The received energy travels at a finite speed along the transmission line 36 such that the inclusion of the transmission line 36 delays the antenna mode 32 by an amount proportional to the length of the meandering transmission line 36. A length corresponding to a delay between the structural mode 54 and the antenna mode 56 of about 3 nanoseconds has been found to be a convenient compromise between tag size and a sufficient delay to allow for ready identification of the antenna mode 56.

Other approaches to introducing a controlled delay are possible. By way of example, passive microwave filters in combination with a different antenna may produce a controlled delay without the use of a transmission line.

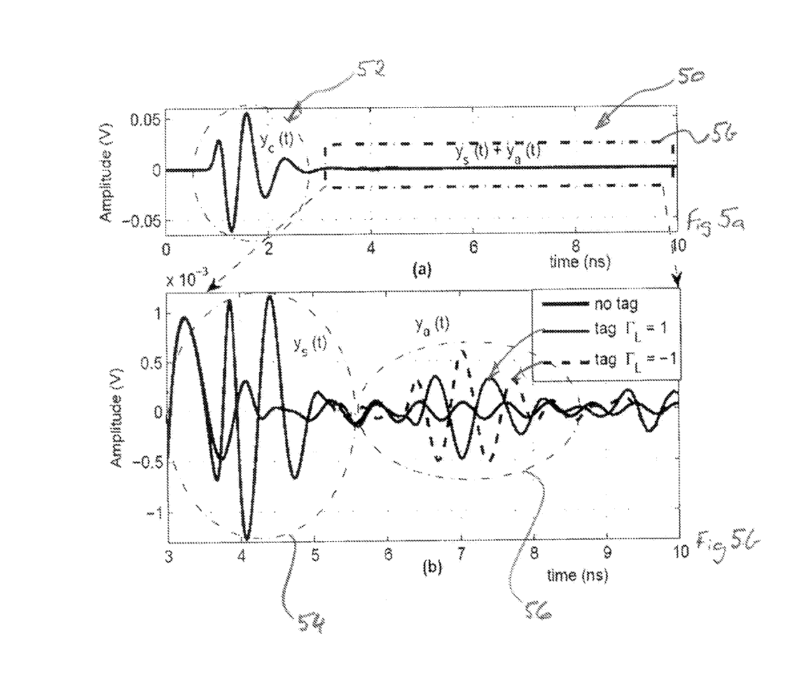

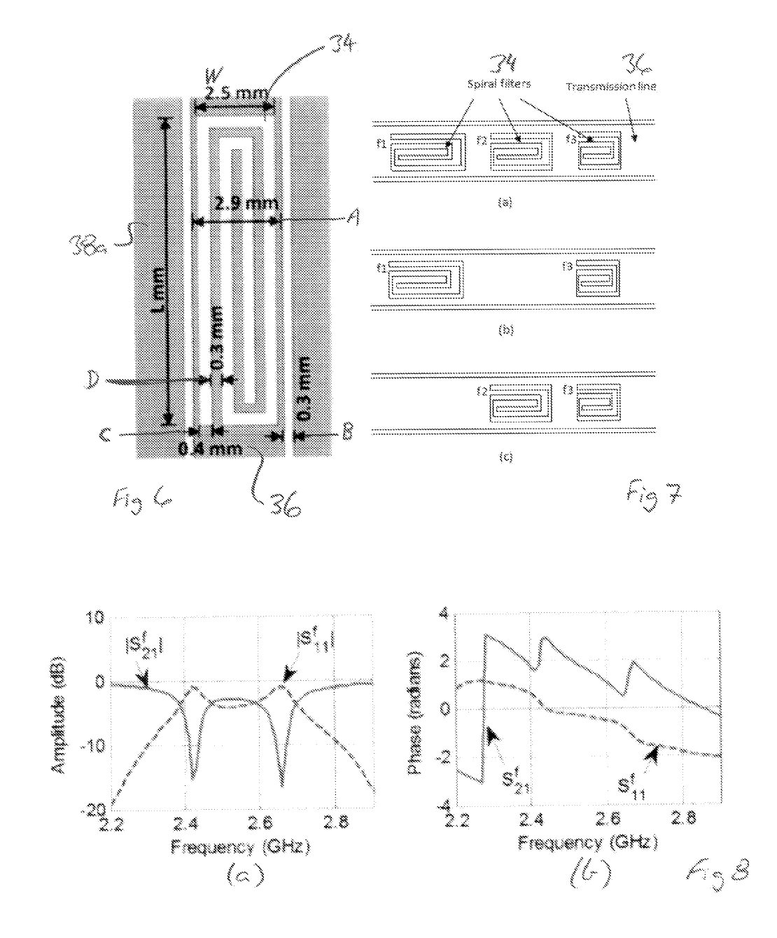

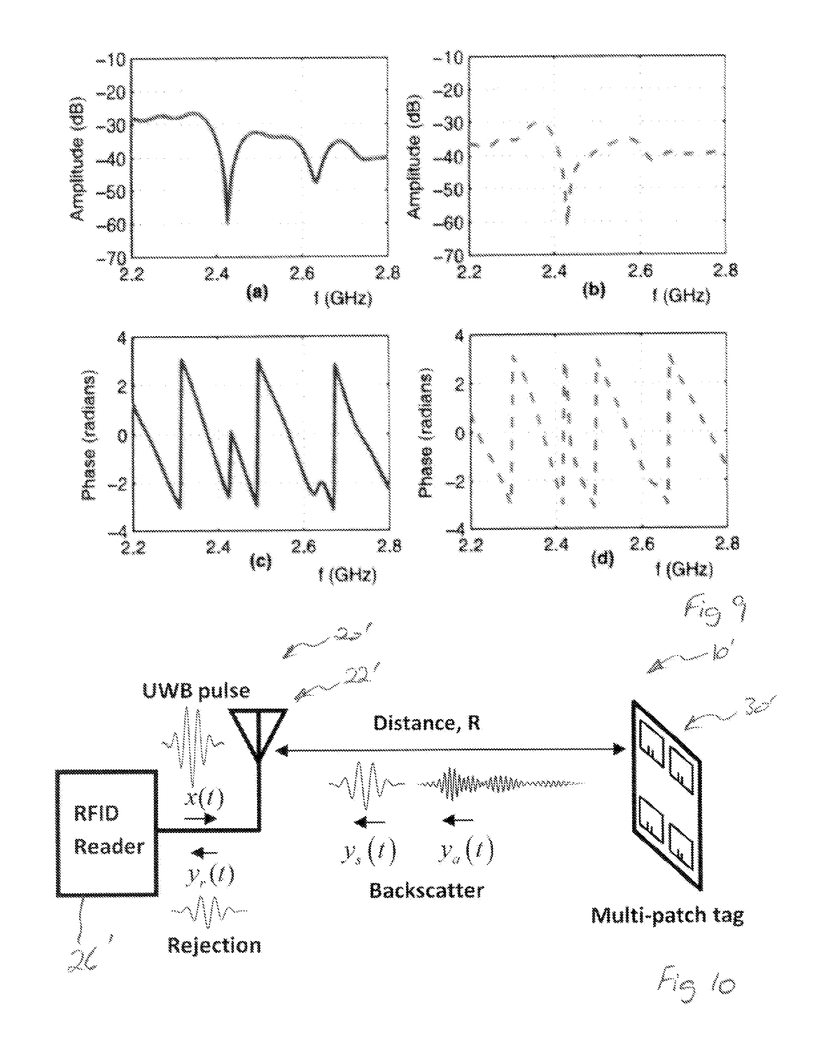

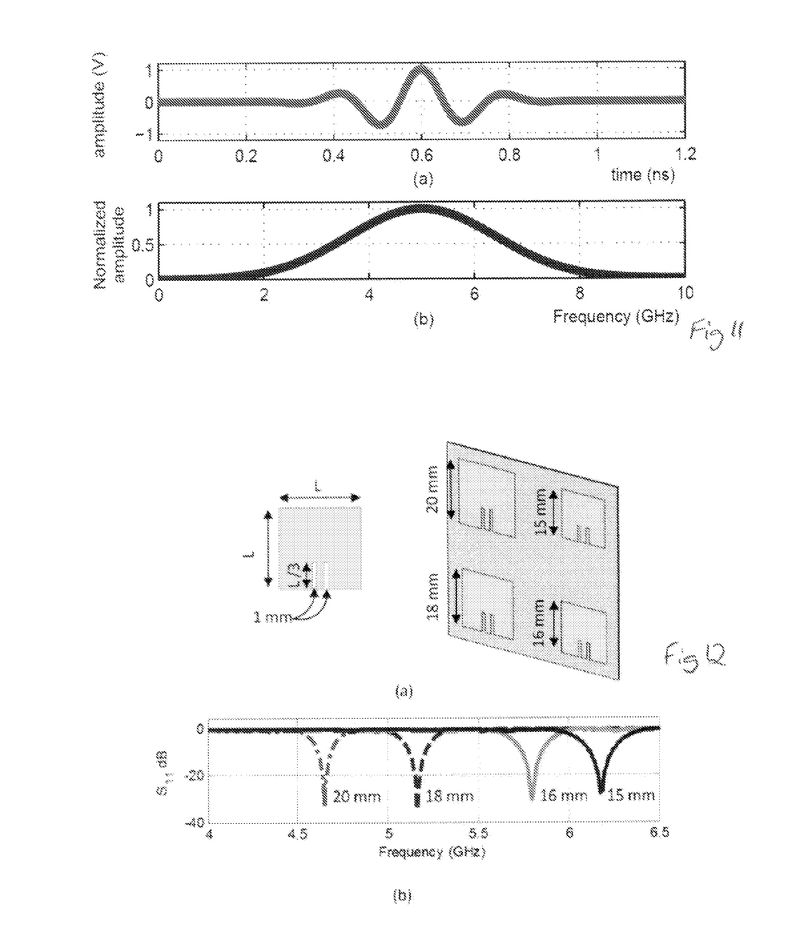

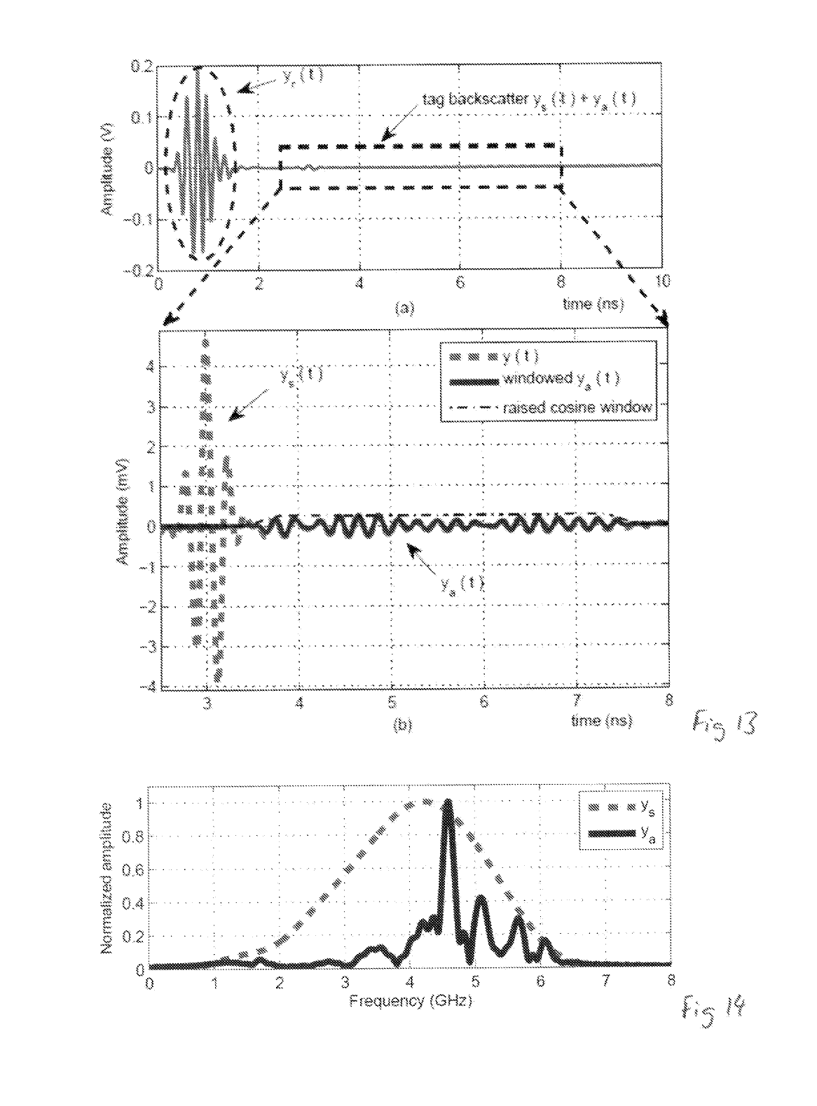

A spiral resonator is but one example of a structure responsive to an interrogation signal to create features at selective frequencies in an antenna mode of a return signal. By way of example, the spiral resonators 34 may be omitted and antenna 32 replaced with a frequency selective tag antenna 32′ including the responsive structures (as suggested in FIG. 4). A frequency selective antenna is an antenna which captures only selected frequencies. Thus configuring a frequency selective antenna is an example of another approach to encoding a tag with information in the frequency domain.

In FIG. 4, the antenna 32′ of tag 30′ conveys only selected ones of a set of predetermined frequencies to the transmission line 36. After time has elapsed for the received energy to travel from the antenna 32′ to and return from the end of the line 36, the selected frequencies are transmitted by the antenna 32′. Thus a return signal from the tag 30′ may carry features identifiable in the frequency domain in the form of local maxima. It is also contemplated that various tags may spectrally shape the return signal to create other identifiable features (e.g. local minima or local extrema generally) within the return signal.

In summary, a new approach to process and read information from a chipless RFID tag is disclosed. This approach utilises an extremely short duration (sub-nanosecond) high power radio frequency impulse. The impulse is transmitted using one antenna and the resulting reflection from the chipless tag is captured by another antenna. The signal received from the antenna is processed in the time domain using signal processing techniques to accurately estimate the resonant frequencies or frequency signature which provide the information encoded in the chipless tag.

Chipless RFID tags possess no integrated circuitry (chip) and are essentially passive reflectors or absorbers of electromagnetic radiation. Due to the absence of any electronic circuitry or any intelligent signal processing, a chipless RFID is essentially the radio frequency counterpart of the ordinary optical barcode. This enables mass production of these tags at very low cost comparable with optical barcodes.

Exemplary apparatus and methods, and proofs of concept, will now be described in further detail.

### EXAMPLE 1

The tag 36 and in particular its filters 34 were designed and simulated using the full-wave EM software “Computer Simulation Technology (CST) Microwave Studio” to have resonant frequencies at 2.42 and 2.66 GHz. Taconic TLX0 (E=2.45) was used as the substrate material. A substrate thickness of 0.5 mm and a copper layer thickness of 18 μm was used in the simulation.

Co-planar waveguide (CPW) circular disc loaded monopole antennas were designed that operate from 1.4 to 4 GHz. These antennas were used as the transmit and receiving antennas of the RFID reader and as the receiving antenna of the chipless RFID tag. The total length of the meandering transmission line in the complete chipless tag from the point of connection to the monopole is 304 mm. This will introduce a round trip delay causing the antenna mode to be lagging approximately 3.2 ns behind the structural mode of the backscatter.

The forward transmission S^{f}₂₁ and the return loss S^{f}₁₁ of the filter is shown in FIG. 8. The spiral filters produce sharp resonances at 2.42 and 2.66 GHz with a 3 dB bandwidth of around 110 MHz.

FIG. 5 shows the simulated received signals at the RFID reader when the distance between the tag and the reader was set to be 45 cm. Three cases were considered: where no tag was present, tag terminated with an open circuit, and tag terminated with a short circuit. For all the three cases the first and strongest component, interference 52 or “y_{c} (t)”, is present. The backscatter components 54, 56 are only present for the two cases where the tag is used as shown in the bottom part of the figure. The first component of the backscatter is identical for both open and short circuited cases. “Open circuit” (Γ_{L}1) refers to the end 36d of transmission line 36 being isolated from the ground plane 38a. “Short circuit (Γ_{L}=−1) is an alternative in which end 36d is directly communicated with ground plane 38a.

FIG. 5 demonstrates the structural mode 54 of the backscattered signal which is independent of end condition of the line 36, Γ_{L}. However, the second component 56 of the backscatter shows a 180° phase difference for the two cases of tag presence which clearly reinforces the effect of Γ_{L}=±1 and enables this component to be identified as the antenna mode. Also the time delay that separates yₛ (t) and yₐ (t) due to the meandering transmission line is also observed in the simulation results.

By keeping all the conditions (distance, orientation, etc) except the loading, Γ_{L}, constant, the component due to antenna mode can be extracted. Let y_{c} (t) and y_{sc} (t) be the total received signals at the reader when the tag is left open circuited (Γ_{L}=1) and short circuited (Γ_{L}=−1) respectively. When these signals are subtracted we obtain:

u(t)=y_{oc}(t)−y_{sc}(t)

The unwanted coupling, backscatter due to structural mode 54 and the first component 52 of the received signal 50 are all removed through the subtraction and only the information carrying component is left. FIGS. 9a and 9c show the simulation results of the spectral content of u (t) obtained by taking the fast Fourier transform. Comparing with FIG. 8 it is clear that u (t) contains the signature of the tag.

In practice, the tag signature may be estimated by first removing the effect of coupling, y_{c} (t), through the subtraction of a tag-less received signal from either y_{oc} (t) or y_{sc} (t) and then windowing out the portion containing the antenna mode and obtaining its spectral content. FIGS. 9b and 9d show the spectral content of such a windowed portion of y_{oc}. This estimate also reveals the frequency signature of the tag, however the observed resonances are not sharp as in FIGS. 9a and 9c. This is because the effect of the interference caused by yₛ (t) is not completely removed as in u (t). With this method, the need for a calibration tag is removed since the antenna mode 56 is estimated solely from either y_{oc} (t) or y_{sc} (t).

Thus by windowing the information carrying portion of the time domain backscatter and obtaining its spectral signature, the frequency signature of the chipless tag can be obtained. The proposed approach does not rely on calibration tags for proper operation.

### EXAMPLE 2A

FIG. 10 illustrates the RFID system 10′. RFID reader 20′ consists of a single antenna 22′ serving as both a transmitter and a receiver. The tag 30′ consists of N inset-fed patch antennas 34′ each resonating at fᵢ with i=1, . . . , N. The signal x (t) is the UWB impulse used for interrogating the chipless RFID tag. The total received signal y (t) (received by logic arrangement 26′ from antenna 22′) consists of three components:

y(t)=yᵣ(t)+yₛ(t)+yₐ(t) (1)

The largest and the first received component, yᵣ (t), is the rejection of the transmit pulse x (t) due to the return loss profile of the antenna. Rejection yᵣ (t) is unwanted signal content analogous to interference 52. Its transients gradually decay down to zero. At this moment in time the antenna has fully transmitted x (t) and is receptive to any backscatter coming from the tag 30′. The second component received, yₛ (t), is the structural mode of the backscatter. This is followed by the antenna mode of the backscatter yₐ (t), which is the weakest and the last component to be received. Let S_{1,1} (f) be the return loss profile of the antenna. From the definition of the return loss, the rejected portion yᵣ (t) of the pulse input into the antenna can be written as:

$$\begin{matrix}{y}_{r} ( t ) = {s}_{1 , 1} ( t ) * x ( t ) \\ = {F}^{- 1} [ {S}_{1 , 1} ( f ) \times ( f ) ] .\end{matrix} \qquad ( 2 )$$

where F⁻¹ (·) denotes the inverse Fourier transform. Herein lower-case letters denote time domain signals and the upper-case letters denote the respective frequency domain signal, i.e. X (f)=F [x (t)]. Due to the presence of a tag in front of the transmit/receive antenna, the original return loss of the antenna, S_{1.1} (f), slightly changes. The return loss of the antenna is affected by the backscatter incident on the antenna and is considered to be electromagnetically loaded by the chipless tag. Let S_{1,1}^{Loaded} (ƒ) be the modified or affected return loss of the antenna. Using S_{1,1}^{Loaded} (ƒ), equation (1) can be rewritten as:

$$\begin{matrix}y ( t ) = {s}_{1 , 1}^{Loaded} ( t ) * x ( t ) \\ = {F}^{- 1} [ {S}_{1 , 1}^{Loaded} ( f ) \times ( f ) ] .\end{matrix} \qquad ( 3 )$$

From (1), (3) and (2) we can write an expression for yₛ (t) and yₐ (t), which introduces the electromagnetic loading in the antenna, as follows:

$$\begin{matrix}{y}_{s} ( t ) + {y}_{a} ( t ) = [ {s}_{1 , 1}^{Loaded} ( t ) - {s}_{1 , 1} ( t ) ] * x ( t ) or \\ = {F}^{- 1} [ [ {S}_{1 , 1}^{Loaded} ( f ) - {S}_{1 , 1} ( f ) ] \times ( f ) ] .\end{matrix} \qquad ( 4 )$$

To obtain a backscattered signal close to realistic conditions, the entire system shown in FIG. 10 was constructed in computer Simulation Technology (CST) Microwave Studio as a 3D model and full-wave electromagnetic simulation was performed.

The UWB pulse used in the simulation is a Gaussian pulse having a bandwidth of 6 GHz. FIG. 11a shows the shape of the transmitted pulse and FIG. 11b shows its frequency spectrum. The pulse is transmitted using a co-planar circular monopole antenna that operates from 2 to 7.3 GHz.

FIG. 12 shows the tag 30′. It includes an array of four inset-fed microstrip patch antennas. Each individual patch antenna resonates at a distinct frequency. By varying the dimensions of the patches, the tag can be engineered to have a unique spectral signature or a transfer function characterised by a set of resonances. This signature can be used to store information. The tag shown in FIG. 12 consists of four square patch antennas 34′, having widths 20, 18, 16 and 15 mm, which resonate at 4.64, 5.16, 5.8 and 6.2 GHz respectively. In this example, the amplitude spectrum is the focus as opposed to the phase spectrum. When the transmitted UWB pulse interacts with the tag, part of it is harnessed by the individual patch antennas 34′ constituting the tag and another part of it is immediately reflected. The initial reflection yₛ (t) is caused by the size and shape of metallic structure of the tag irrespective of the resonant properties of the patches. Following this initial backscatter is a secondary backscatter, the antenna mode yₐ (t), which is made up of the signals captured by the individual patches at their respective resonant frequencies. The strength of this re-radiated signal is determined by the loading condition of each patch. This example includes an open circuit loading condition to maximise the antenna mode backscatter.

The dimension L of each patch 34′ determines its resonant frequency. The tag includes a substrate of Taconic TLX-8 with ε=2.55 and thickness 0.5 mm. FIG. 12b charts the S_{1,1} characteristics of each patch antenna.

FIG. 13 shows the complete received signal y (t) when the tag is placed 30 cm away from the antenna. Once the initial rejection yᵣ (t) has faded away, it is clearly observed that the antenna picks up the backscatter from the tag after a propagation delay of 2.55 ns. The backscatter consists of a larger component followed by transients. It is thought that the larger component is the structural mode yₛ (t) and the transients make up the yₐ (t).

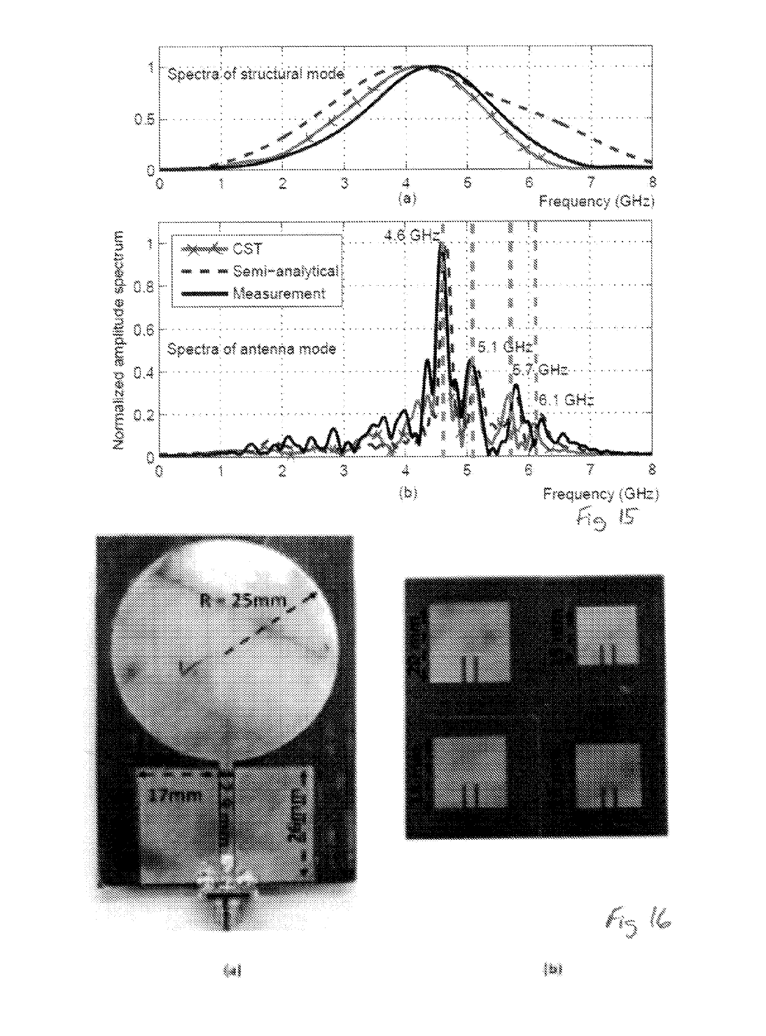

FIG. 14 shows the spectral content of the windowed structural mode and windowed antenna mode obtained using the fast Fourier transform (FFT). A raised cosine window was used to approximately window out yₛ (t) and yₐ (t). It is clear that yₛ (t), the larger and first portion of the backscatter, has a Gaussian amplitude spectrum similar to the spectrum of the transmitted UWB pulse and does not contain any information of the resonant frequencies of the patches. On the other hand, the spectral content of the windowed yₐ (t) clearly reveals the resonant frequencies (4.6, 5.1, 5.7 and 6.1 GHz) of the individual patch antennas. Therefore, it is clear that the transients (yₐ (t)) following the initial strong backscatter (yₛ (t)) holds the information required to estimate the resonant frequencies of the patches in the chipless tag. It is also observed that the height of the peaks corresponding to the resonances closely follow a contour of a Gaussian amplitude spectrum. This is partly because the amplitude-spectra of the transmitted pulse is Gaussian as seen in FIG. 11b. The antenna mode simply consists of a filtered version of the transmitted signal where signals corresponding to the resonances will only be present. It should also be noted that the resonance information was obtained solely by using the backscatter from the tag and did not require any additional calibration through a calibration tag.

### EXAMPLE 2B

### Experimental Validation

In this section an experimental validation of the simulation results of Example 2A is outlined.

Experiments were performed in an anechoic chamber environment. The experiments were conducted using a vector network analyser (Agilent PNA E8361A) where the measurements were taken in the frequency domain. These measured data were then converted to the time domain using signal processing techniques.

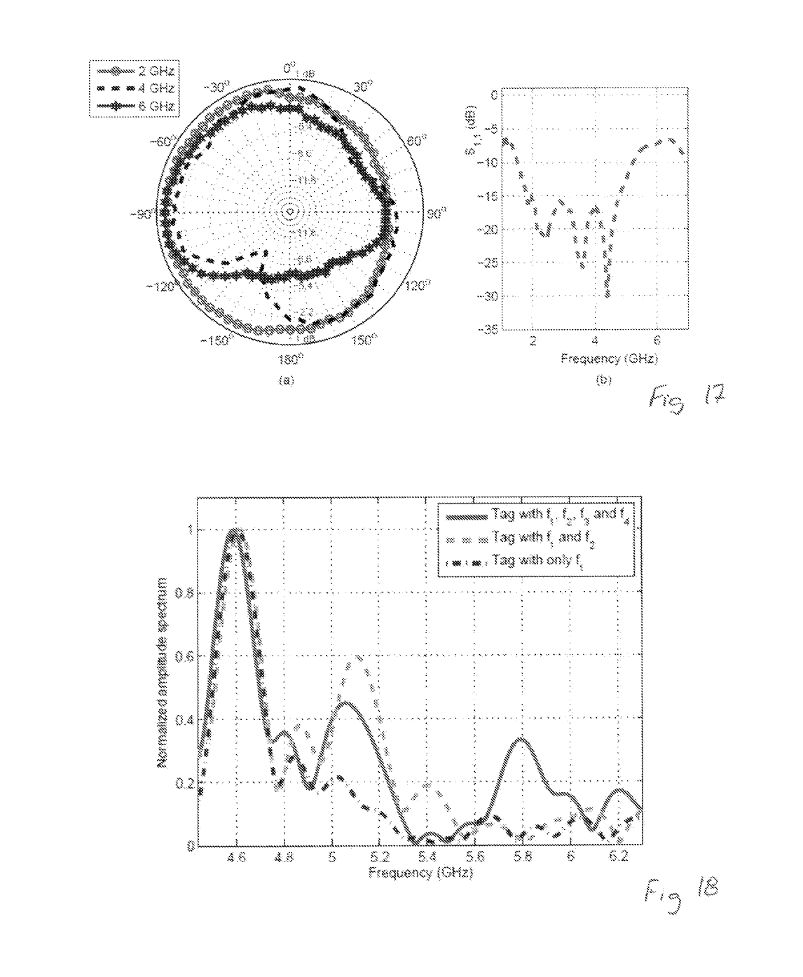

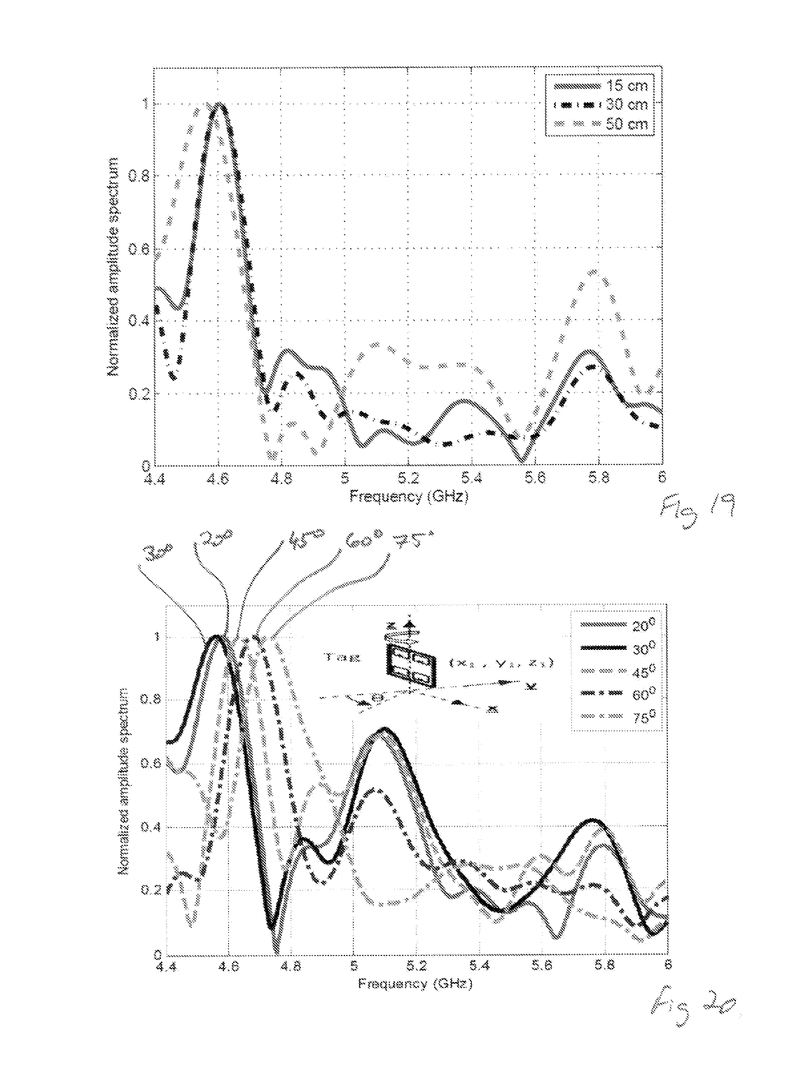

Interrogation signals were transmitted and received using a single co-planar monopole antenna. FIG. 16a shows the antenna used for the experiment. The antenna was fabricated on a Taconic TLX-8 substrate material having thickness of 0.5 mm with copper cladding thickness of 17 um and a dielectric constant of 2.55. The measured return loss and the E-field radiation patterns for the antenna are shown in FIGS. 17a and 17b respectively. The antenna performs well from 1.5 GHz to 5 GHz. The return loss profile degrades after 5 GHz. The radiation pattern is omni-directional for lower frequencies and becomes directive at higher frequencies. The chipless RFID tag used in the experiment is shown in FIG. 16b.

Measurements were taken in an anechoic chamber where a single port measurement was carried out with a vector network analyser. The experiment included two steps. First the loaded return loss profile of the antenna, S_{1,1}^{Loaded}, was measured where the presence of the tag would affect the return loss profile of the antenna. Next the un-loaded return loss of the antenna, S_{1,1}, was measured with an empty chamber without the tag. By applying equation (4) on these experimental frequency domain measurements the time domain backscatter from the tag, yₛ (t)+yₐ (t), was obtained. Using a raised cosine window yₛ (t) and yₐ (t) are windowed as in Example 2A. This involves multiplying the backscatter (yₛ (t)+yₐ (t)) by w(t), wherein:

$$w ( t ) = \{ \begin{matrix}0 ; & t < {t}_{0} - \frac{τ}{2} \\ \frac{1}{2} - \frac{1}{2} cos ( \frac{π ( t - {t}_{0} + \frac{τ}{2} )}{τ} ) ; & {t}_{0} - \frac{τ}{2} \leq t < {t}_{0} + \frac{τ}{2} \\ 1 ; & {t}_{0} + \frac{τ}{2} \leq t < {t}_{0} + \frac{τ}{2} + T \\ \frac{1}{2} + \frac{1}{2} cos ( \frac{π ( t - {t}_{0} - \frac{τ}{2} - T )}{τ} ) ; & {t}_{0} + \frac{τ}{2} + T \leq t < {t}_{0} + \frac{3 τ}{2} + T \\ 0 ; & t \geq {t}_{0} + \frac{3 τ}{2} + T\end{matrix}$$

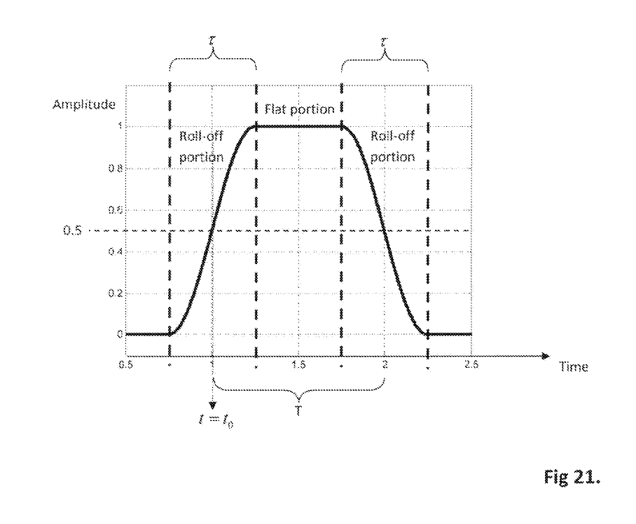

τ is the roll-off duration (or roll-off portion of the window) during which the window rises or falls with a sinusoidal shape, T is the duration of the window, and t₀ is the starting time of the window. FIG. 21 illustrates a w(t).

The amplitude spectra of the windowed yₛ (t) and yₐ (t) are shown in FIG. 15. FIG. 15 also charts the results of a semi-analytical approximation in which the entities (antenna, wireless channel and patches of tag) constituting the total system are approximated as linear time invariant (LTI) subsystems that can each be fully described using a specific transfer function. It is clear that the measurement results are in accordance with the simulation result and the semi-analytical result. It should be noted that the results obtained did not rely on the use of a calibration tag.

The performance of the proposed technique was tested experimentally where the tag was placed in different orientations and locations with respect to the reader antenna. FIG. 18 shows the frequency-spectra of chipless tags having different combinations of resonant patches (f₁=4.6 GHz, f₂=5.1 GHz, f₃=5.7 GHz and f₄=6.1 GHz). The result confirms that the presence of a resonant patch antenna in the chipless tag causes a corresponding peak in the spectral signature of the chipless tag. With the proto-type tag consisting of four distinct patch antennas it is possible to encode four data bits where the presence of a patch represents a “1” bit and its absence signifies a “0” bit. The performance of the chipless RFID system at different distances is shown in FIG. 19. As the distance increases, the signal to noise ratio degrades which causes ambiguity in the detection of resonant peaks in the spectral signature at higher frequencies. The frequency-spectra of the chipless tag was successfully estimated up to a distance of 50 cm, where a transmission power of 1 mW was used by the network analyser.

FIG. 20 shows the performance of the chipless tag, having resonant patches f₁, f₂ and f₃, under rotation. It is clear from the results that for rotations less than 45° the spectral signature of the chipless tag can be estimated using the proposed technique without any additional signal processing. All the three resonant frequencies of the tag can be clearly distinguished. However, when the tag is rotated beyond 45° the performance degrades and some of the higher resonant frequencies do not appear in the estimated frequency spectra. Here, the rotation was such that the patches corresponding to the higher frequencies would face away from the reader antenna while the patches corresponding to lower frequencies would face toward the reader antenna. This would explain why the higher resonant frequencies degrade while the lower ones still appear to be affected less by the rotation. A frequency shift is also observed particularly in the peak corresponding to f₁. The directive radiation pattern of the transmit/receive antenna at higher frequencies, as shown in FIG. 17, would also be a reason for this behaviour under rotations. When a sufficiently large guard band (200 MHz) is utilised between the resonant frequencies, the effect of this shift on the detection performance can be negated.

1. A method of reading an RFID tag including:
receiving, from the tag, a signal including a structural mode and an antenna mode; and
selectively analyzing a time period of the received signal corresponding to the antenna mode.

2. The method of claim 1, wherein the selectively analyzing includes identifying within the received signal features at selected frequencies of a predetermined set of frequencies.

3. The method of claim 1, further including identifying a predetermined delay, from a portion of the received signal to another portion of the received signal, to identify the time period.

4. The method of claim 3, wherein the portion is a structural mode of the received signal and the other portion is the antenna mode.

5. The method of anyone of claim 1, further including subtracting an estimate of unwanted signal content to identify the received signal.

6. The method of claim 5, wherein the estimate corresponds to a signal when no tag is present.

7. The method of claim 1, wherein the selectively analyzing includes Fourier analysis.

8. The method of claim 1, further including transmitting an interrogation signal to the tag to create the signal from the tag.

9. The method of claim 8, wherein the interrogation signal is a pulse containing a broadband of frequencies.

10. The method of claim 8, wherein the interrogation signal is less than a nanosecond in duration.

11. The method of claim 1, wherein the tag is chipless.

12. A reader for reading an RFID tag including:
an antenna configured to receive, from the tag, a signal including a structural mode and an antenna mode; and
a logic arrangement configured to selectively analyze a time period of the received signal corresponding to the antenna mode of the received signal.

13. The reader of claim 12, wherein the logic arrangement is further configured to identify within the received signal features at respective frequencies of a predetermined set of frequencies.

14. The reader of claim 12, wherein the logic arrangement is configured to identify a predetermined delay, from a portion of the received signal to another portion of the received signal, to identify the time period.

15. The reader of claim 14, wherein the portion is a structural mode of the received signal and the other portion is the antenna mode.

16. The reader of claim 12, wherein the logic arrangement is configured to subtract an estimate of unwanted signal content to identify the received signal.

17. The reader of claim 16, wherein the estimate corresponds to a signal when no tag is present.

18. The reader of claim 12, wherein the logic arrangement is configured to perform Fourier analysis in selectively analyzing the time period.

19. The reader of claim 12, further including an antenna configured to transmit an interrogation signal to the tag to create the signal from the tag.

20. The reader of claim 19, wherein the interrogation signal is a pulse containing a broadband of frequencies.

21. The reader of claim 19, wherein the interrogation signal is less than a nanosecond in duration.

22. The reader of claim 12, wherein the tag is chipless.

23. A chipless RFID tag including:
one or more structures responsive to an interrogation signal to create features at selected frequencies in an antenna mode of a return signal; and
at least one elongate conductive pathway co-operable with the structures to delay the antenna mode from a structural mode of the return signal.

24. The tag of claim 23, wherein the tag carries information encoded by the selection of the frequencies from a predetermined set of frequencies.

25. The tag of claim 24, wherein the predetermined frequencies are respectively separated by at least about 200 MHz.

26. The tag of claim 23, wherein the pathway is dimensioned to delay the antenna mode from a structural mode such that the delay between the antenna mode and the structural mode is at least about 0.6 ns.

27. The tag of claim 23, wherein the delay between the antenna mode and the structural mode is at least about 3 ns.

28. The tag of claim 23, wherein one or more of the structures are positioned along the pathway.

29. The tag of claim 23, further including a frequency selective antenna including one or more of the structures.

30. The tag of claim 23, wherein one or more of the structures are passive filters.

31. The tag of claim 30, wherein the one or more of the structures are spiral filters.

32. The tag of claim 23, further including an antenna to receive the interrogation signal and transmit the return signal, wherein an end of the pathway is arranged to receive energy from the antenna and another end of the pathway is arranged to reflect energy toward the antenna.

33. The tag of claim 23, wherein the pathway is shaped such that portions of the pathway
